(19) United States
(12) Patent Application Publication
(10) Pub. No.: US 2026/0342858 A1
(43) Pub. Date: Oct. 29, 2026

(54) CONTINUOUS VISIBILITY OF SHADOW GENERATIVE AI WORKLOADS

(71) Applicant: Netskope, Inc., Santa Clara, CA (US)

(72) Inventor: Siying Yang, Saratoga, CA (US)

(73) Assignee: Netskope, Inc., Santa Clara, CA (US)

(21) Appl. No.: 19/370,525

(22) Filed: Oct. 27, 2025

Related U.S. Application Data
(60) Provisional application No. 63/797,059, filed on Apr. 29, 2025.

(51) Int. Cl. H04L 9/40

(52) U.S. Cl. CPC H04L 63/20; H04L 63/1433

(57) ABSTRACT

A shadow generative artificial intelligence (GenAI) detection system for providing continuous visibility of shadow GenAI workloads. Download of a GenAI model on an end-user device is initiated by a user of an enterprise from host repositories of a hosting site. The host repositories include uniform resource locators (URLs) of the GenAI model and associated workload components. An enterprise repository is generated with the URLs of the GenAI model from the host repositories. The host repositories are monitored for updating the enterprise repository that has policies associated with the GenAI model. A mid-link server between the end-user device(s) and an enterprise server deploys a Secure Web Gateway (SWG) or an inline Cloud Access Security Broker (CASB) device to detect the downloading of the GenAI model on the end-user device. A policy from the enterprise repository is applied based on the downloading of the GenAI model on the end-user device.

### PRIORITY

This application is a continuation of U.S. Provisional Patent Application No. 63/797,059, filed Apr. 29, 2025 entitled “CONTINUOUS VISIBILITY OF SHADOW GENERATIVE AI WORKLOADS,” the contents of which are hereby incorporated by reference in their entirety for all purposes.

### BACKGROUND

This disclosure relates in general to detecting generative artificial intelligence (GenAI) usage and, not by way of limitation, to detecting GenAI workload on an enterprise computing infrastructure, among other things.

GenAI technologies, especially large language models (LLM), have brought huge productivity improvement in many verticals. At the same time, these technologies also bring security, privacy and ethical challenges. Big enterprises are adopting the GenAI technologies rapidly while most, if not all, of them implement guardrails for the GenAI tools to deal with the potential risks. In all cases, the first step of implementing guardrails is to have continuous visibility on what GenAI tools are being used within the organization.

### SUMMARY

In one embodiment, the present disclosure provides a shadow GenAI detection system for providing continuous visibility of shadow GenAI workloads. Download of a GenAI model is initiated on an end-user device of the user by a user of an enterprise from host repositories of a hosting site. The host repositories include uniform resource locators (URLs) of the GenAI model and associated workload components. An enterprise repository is generated with the URLs of the GenAI model from the host repositories. The host repositories are monitored for updating the enterprise repository that has policies associated with the GenAI model. A mid-link server between the end-user device(s) and an enterprise server deploys a Secure Web Gateway (SWG) or an inline Cloud Access Security Broker (CASB) device detect the downloading of the GenAI model on the end-user device. A policy from the enterprise repository is applied based on the downloading of the GenAI model on the end-user device.

In an embodiment, a method for providing continuous visibility of shadow GenAI workloads. The method comprises receiving initiation of a download of a GenAI model from one or more host repositories of a hosting site. The one or more host repositories include URLs of the GenAI model, and data associated with model owner, model source repositories, model partner, open-source models, and model containers. The method further comprises generating an enterprise repository with the URLs of the GenAI model by retrieving the URLs from the one or more host repositories. The method further comprises monitoring the one or more host repositories for updating the enterprise repository. The enterprise repository has a plurality of policies associated with a corresponding GenAI model. The method further comprises detecting by a mid-link server, the downloading of the GenAI model. The mid-link server is between a plurality of end-user devices of a plurality of users and an enterprise server, and the mid-link server deploys a SWG or an inline SWG device for detecting the downloading of the GenAI model, and the SWG and the inline CASB device are deployed at the enterprise server to intercept encrypted network traffic from the plurality of end-user devices to the hosting site and applying a policy from the plurality of policies from the enterprise repository based on the detection of the downloading of the GenAI model.

In another embodiment, a system for providing continuous visibility of shadow GenAI workloads. The system comprises one or more processors, and memory couples with the one or more processors, the memory configured to store instructions that when executed by the one or more processors cause the one or more processors to receive initiation of a download of a GenAI model from one or more host repositories of a hosting site. The one or more host repositories include URLs of the GenAI model, and data associated with model owner, model source repositories, model partner, open-source models, and model containers. The one or more processors further configured to generate an enterprise repository with the URLs of the GenAI model by retrieving the URLs from the one or more host repositories.

The one or more processors further configured to monitor the one or more host repositories for updating the enterprise repository. The enterprise repository has a plurality of policies associated with a corresponding GenAI model. one or more processors further configured to detect by a mid-link server, the downloading of the GenAI model. The mid-link server is between a plurality of end-user devices of a plurality of users and an enterprise server, and the mid-link server deploys a SWG or an inline SWG device for detecting the downloading of the GenAI model, and the SWG and the inline CASB device are deployed at the enterprise server to intercept encrypted network traffic from the plurality of end-user devices to the hosting site and apply a policy from the plurality of policies from the enterprise repository based on the detection of the downloading of the GenAI model.

In yet another embodiment, a non-transitory computer-readable storage medium having stored thereon instructions for causing at least one computer to provide continuous visibility of shadow GenAI workloads, the instructions comprising:
receiving initiation of a download of a GenAI model from one or more host repositories of a hosting site, wherein the one or more host repositories include URLs of the GenAI model, and data associated with model owner, model source repositories, model partner, open-source models, and model containers;
generating an enterprise repository with the URLs of the GenAI model by retrieving the URLs from the one or more host repositories;
monitoring the one or more host repositories for updating the enterprise repository, wherein the enterprise repository has a plurality of policies associated with a corresponding GenAI model;
detecting by a mid-link server, the downloading of the GenAI model, wherein the mid-link server is between a plurality of end-user devices of a plurality of users and an enterprise server, and the mid-link server deploys a SWG or an inline SWG device for detecting the downloading of the GenAI model, and the SWG and the inline CASB device are deployed at the enterprise server to intercept encrypted network traffic from the plurality of end-user devices to the hosting site; and
applying a policy from the plurality of policies from the enterprise repository based on the detection of the downloading of the GenAI model.

Future areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 illustrates a block diagram of a shadow GenAI detection system.

FIG. 2 illustrates a block diagram of a mid-link server that hosts end-user device(s) using a secured software environment.

FIG. 3 illustrates a block diagram of an end-user device that uses an end-user to establish connections with a mid-link server.

FIG. 4 illustrates a block diagram of internal components of a mid-link server.

FIG. 5 illustrates a block diagram of an embodiment of an Open Systems Interconnection (OSI) model.

FIG. 6 illustrates a flowchart of an embodiment of providing continuous visibility of shadow GenAI workloads using a SWG or an inline SWG device.

FIG. 7 illustrates a flowchart of an embodiment of providing continuous visibility of shadow GenAI workloads using a list of Graphical Processing Units (GPUs) exceeding a threshold value.

FIG. 8 illustrates a flowchart of an embodiment of providing continuous visibility of shadow GenAI workloads by scanning network traffic between an end-user device and the GenAI workload server.

FIG. 9 illustrates a flowchart of an embodiment of providing continuous visibility of shadow GenAI workloads using application-level (HTTP/HTTPS) requests/responses.

FIG. 10 illustrates a flowchart of an embodiment of providing continuous visibility of shadow GenAI workloads using a confidence score based on the detection of the downloading of the GenAI model.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

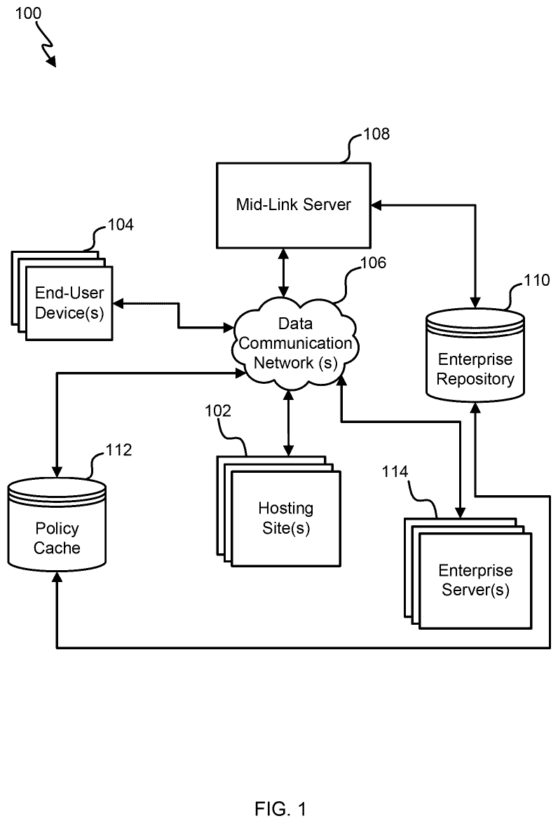

Referring to FIG. 1, a block diagram of a shadow GenAI detection system 100 is illustrated. The shadow GenAI detection system 100 identifies GenAI and associated components on end-user device(s) 104 of users of an enterprise. The shadow GenAI detection system 100 includes several hosting site(s) 102, end-user device(s) 104, data communication network(s) 106, a mid-link server 108, an enterprise repository 110, a policy cache 112, and an enterprise server(s) 114. The number of hosting site(s) 102, the end-user device(s) 104, the mid-link server 108, the enterprise repository 110, the policy cache 112, and the enterprise server(s) 114 are connected by the data communication network(s) 106.

A user of the enterprise uses an end-user device(s) 104 to initiate the download of a GenAI model from multiple host repositories of a hosting site(s) 102. The GenAI model is to be downloaded on the end-user device(s) 104 of the user. The number of host repositories includes URLs of the GenAI model, as well as data associated with the model owner, model source repositories, model partners, open-source models, and containers.

The mid-link server 108 is between several end-user device(s) of the number of users and an enterprise server(s) 114. The enterprise server(s) 114 manage the policies of the policy cache 112. The mid-link server 108 detects the downloading of the GenAI model on the end-user device(s) 104. The mid-link server 108 deploys a SWG or an inline SWG device for detecting the downloading of the GenAI model on the end-user device(s) 104.

A policy from the list of policies is applied by the mid-link server 108, based on the policy cache 112 and the enterprise repository 110, upon detection of the downloading of the GenAI model on the end-user device(s) 104. In some embodiments, the mid-link server 108 maintains an updated list of trusted or restricted GenAI sources by continuously syncing with external repositories and applying changes to the enterprise repository 110.

The enterprise repository 110 is generated with the URLs of the GenAI model by retrieving the URLs from the number of host repositories of the hosting site(s) 102. The number of host repositories is monitored by the mid-link server 108 for updating the enterprise repository 110. The enterprise repository 110 has several policies associated with a corresponding GenAI model retrieved from the policy cache 112.

The policy cache 112 includes a list of policies defined by the enterprise regarding actions taken on the GenAI downloads on the end-user device(s) 104 by the users. The policies include initiating alerts to the enterprise administrator when the download of the GenAI model is detected on the end-user device(s) 104 or partially or fully blocking or permitting access to the GenAI model. The policies are updated by the enterprise server(s) 114 based on the actions associated with the policies identified from the policy cache 112 and updates from the enterprise repository 110.

In some embodiments, the mid-link server 108 utilizes machine learning operation tools (MLOps) to detect the downloading of a framework for the GenAI model on the end-user device(s) 104. The MLOps added to the monitoring list in the enterprise repository 110 include Weights and Biases, LangChain, LlamaIndex, SpinQuant, PyTorch, TensorFlow, Qdrant, MLFlow, Metaflow, and Ollama. The downloading of the framework involves fine-tuning, quantization, and integration of the GenAI model with other production components.

In some embodiments, the shadow GenAI detection system 100 provides continuous visibility of shadow GenAI workloads, the instructions that, when executed by several processors, further cause the number of processors to be detected by the mid-link server 108, downloading of the GenAI model on the end-user device(s) 104, and downloading of GenAI-related workload components. The GenAI-related workload components include a proxy server, a Software Development Kit (SDK), and GenAI guardrails. The shadow GenAI detection system 100 further controls the number of processors to apply a policy from the number of policies based on the detection of the GenAI-related workload components on the end-user device(s) 104, and the shadow GenAI detection system 100 further controls the number of processors to update the number of policies based on an updated enterprise repository 110. The number of policies includes sending alerts to an enterprise administrator, blocking or permitting the installation of the GenAI model.

In some embodiments, the shadow GenAI detection system 100 further causes the mid-link server 108 to utilize a specified number of processors, an artificial intelligence (AI) red teaming tool for validating the end-user device(s) 104. The shadow GenAI detection system 100 further controls the number of processors to identify vulnerabilities on the end-user device(s) 104 based on the validation. The shadow GenAI detection system 100 further controls the number of processors to apply a policy from the number of policies on the end-user device 104 based on the validation.

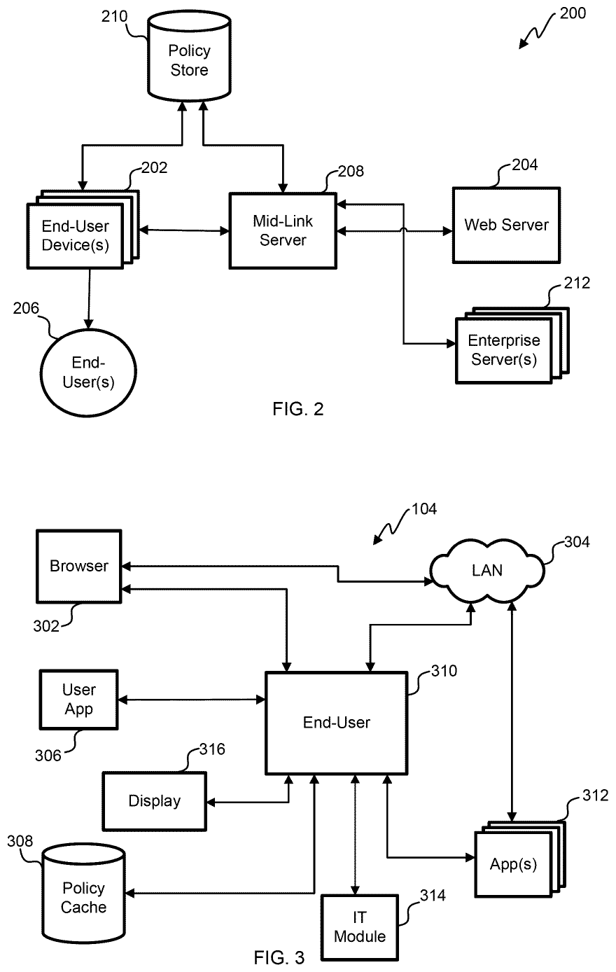

Referring to FIG. 2, a block diagram of a system 200 is shown. The system 200 includes end-user device(s) 202, a web server 204, end-user(s) 206, a mid-link server 208, a policy store 210, and enterprise server(s) 212. The end-user device(s) 202, such as smartphones, tablets, PCs, and other computing devices, communicate with the web server 204 via encrypted internet links. The end-user device(s), 104 may be secured by using the mid-link server 208, which remotely hosts a secure software environment. The end-user device(s) 202 run any popular operating system (OS) such as Windows™, iOS™, Android™ Linux, set-top box OSes such as Real-Time Operating System (RTOS), Unix OS, Linux-Kernel, and Linux OS in the Internet of Things (IOT)/Industrial control systems (ICS)/Distributed Control Systems (DCS)/Operational Technology (OT), and Chromebook™—the operating system of the end-user device(s) 202 runs third-party apps.

The policy store 210 (or a policy component) holds policies for individual end-user device(s) 202 and the mid-link server 208.

In some embodiments, the mid-link server 208 acts as a security and policy enforcement layer between the end-user device(s) 202 and the number of hosting site(s) 102. The mid-link server 208 monitors traffic patterns and URL requests from the end-user device(s) 202 to the web server 204 and identifies when a download is initiated from a number of hosting site(s) 102. The mid-link server 208 uses SWG or inline SWG technologies to detect unauthorized GenAI usage. The mid-link server 208 applies enterprise-specific policies stored in the policy store 210. The policies may include blocking unauthorized downloads, logging attempted access, or alerting the enterprise administrator in real time.

The web server 204 includes hosting platforms such as model repositories, collaboration applications, and GenAI-enabled services that provide GenAI models to the end-user device(s) 202. The web server 204 serves as the primary source of GenAI models and related components that may be requested by the end-user(s) 206 of the end-user device(s) 202. The web server 204 also permits the end-user(s) 206 to upload or download GenAI models, datasets, and associated GenAI components from the hosting platforms. The web server 204 communicates with the end-user device(s) 202 via the mid-link server 208 over the internet-connected network.

The policy store 210 is a database that includes predefined policies for authorizing the end-user(s) 206 to access or download GenAI models from the web server 204. The policy store 210 also maintains aggregated risk assessments associated with the end-user(s) 206 on end user device(s) 202 for downloading, installing, or executing GenAI models. The aggregated risks are mapped to corresponding policies, which determine whether a GenAI download or usage event is permitted, blocked, or flagged for administrative review. The detection of unauthorized GenAI models is performed by monitoring requests and downloads through the mid-link server 208 using enterprise-defined rules. The policies may be predefined by the enterprise administrator for the end-user device(s) 202, and modified policies are also stored in the policy store 210 as updated by the enterprise administrator.

The enterprise server(s) 212 are secured cloud interfaces, on-premise servers, or cloud-hosted platforms of the enterprise that manages policies and governance for GenAI usage. The enterprise server(s) 212 authorize users and enforce enterprise-defined controls when end-user(s) 206 attempt to access or download GenAI models. The enterprise server(s) 212 are in communication with the policy store 210 to fetch, update, and apply policies related to GenAI activities. User access to the enterprise server(s) 212 is provisioned at the time of joining the enterprise and revoked when the user becomes unauthorized or leaves the enterprise.

Referring to FIG. 3, a block diagram of an end-user device(s) 104 that communicate with the mid-link server 108 for shadow GenAI detection is shown. The end-user device(s) 104 include a browser 302, a Local Area Network (LAN) 304, a user app 306, a policy cache 308, an end-user 310, app(s) 312, an Information Technology (IT) module 314, and a display 316. The end-user device(s) 104 execute applications (apps) 312 and a browser 302 that enables the end-user 310 to initiate connections over the LAN 304 for accessing external hosting sites 102 or enterprise-approved services. The browser 302 and the app(s) 312 may be redirected through domain name services (DNS) or policy-driven enforcement to route traffic via the mid-link server 108. Alternatively, the browser 302 and the app(s) 312 may natively integrate with the mid-link server 108 through Application Programming Interfaces (APIs) or security modules that enforce policies related to GenAI downloads and usage. The policy cache 308 is the same as the policy cache 112 and stores enterprise policies locally on the end-user device(s) 104. The user app 306 provides access to remote applications or GenAI-enabled services, and the IT module 314 ensures compliance with enterprise rules by monitoring activities and reporting unauthorized attempts to download or execute GenAI models. The display 316 facilitates user interaction with enterprise-secured applications, alerts, and policy enforcement notifications related to GenAI activities.

In some embodiments, the user app 306 may be a local application that enables access to GenAI-enabled services or remote enterprise applications through the mid-link server 108. The entire interface of the GenAI-enabled service may be displayed, or a single application window may be presented to the end-user 310. Several instances of the user app 306 could display multiple GenAI or enterprise application interfaces simultaneously. For example, a user of a Chromebook™ may have one user app 306 session interacting with an iOS™ application and another session with a Linux™ application, with the ability to switch between full-screen or windowed modes. In other embodiments, the user app 306 may simply be a browser 302 or video client displaying policy-controlled GenAI content. Policies for such applications are defined based on the aggregate risk associated with the end-user 310.

In some embodiments, the policy cache 308 stores enterprise policies that are locally applied on the end-user device(s) 104. The policy cache 308 is synchronized with the policy store 210 via the mid-link server 108 to ensure updated policies are enforced. Policies stored in the policy cache 308 are used by client-side modules to govern the behavior of the browser 302, user app 306, or app(s) 312 communicating over the LAN 304 with external hosting site(s) 102 through the mid-link server 108.

In some embodiments, the IT module 314 provides an interface for the enterprise administrator to review policy activity, alerts, and violations generated on the end-user device(s) 104. The IT module assists the enterprise administrator in analyzing reports of shadow GenAI activity and assigning updated policies to end-user device(s) 104 based on compliance requirements.

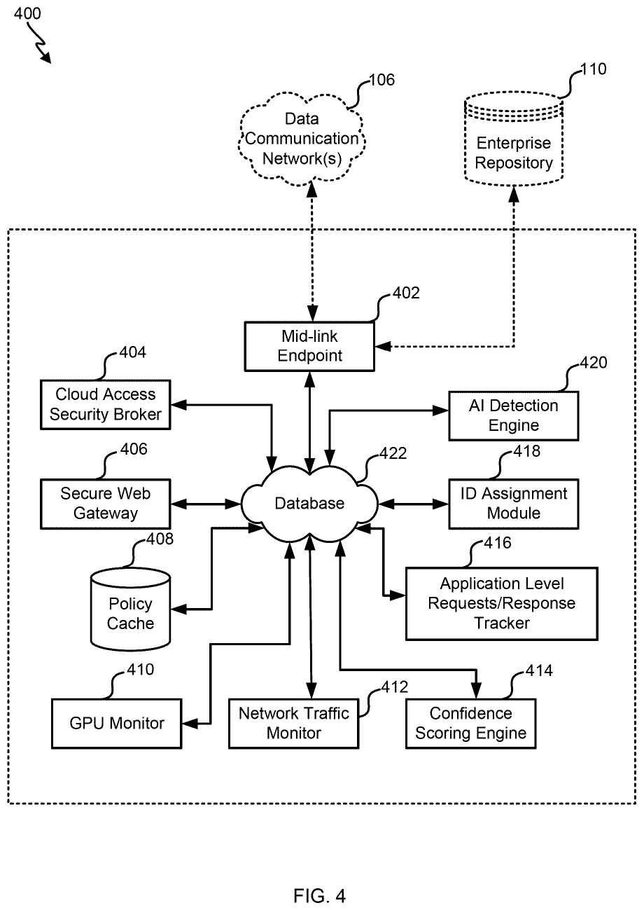

Referring to FIG. 4, a block diagram of internal components of a mid-link server 400 is shown. The mid-link server 400 is same as the mid-link server 108. The mid-link server 400 includes a mid-link endpoint 402, a SWG 404, a SWG 406, a policy cache 408, a graphical processing unit (GPU) monitor 410, a network traffic monitor 412, a confidence scoring engine 414, an application-level requests/response tracker 416, an identity (ID) assignment module 418, an AI detection engine 420, and a database 422. The mid-link endpoint 402 is connected to the data communication network(s) 106 and also interfaces with the enterprise repository 110 to synchronize GenAI model URLs, policies, and risk information. The database 422 is the common point of communication and storage for the remaining components of the mid-link server 400.

The mid-link endpoint 402 serves as the communication interface between the end-user device(s) 104 and the external hosting site(s) 102. The mid-link endpoint 402 ensures that the traffic is routed through the mid-link server 400, providing visibility into GenAI-related downloads and activities. The mid-link endpoint 402 also establishes secure tunnels for traffic and maintains synchronization with the enterprise repository 110 such that the recent URLs, metadata, and enterprise policies are available for enforcement.

The SWG 404 inspects and controls cloud-based connections initiated from the end-user device(s) 104. The cloud access security broker 404 identifies attempts to access or download GenAI models from external repositories and enforces enterprise-defined policies. The CASB 404 enables inline policy enforcement, blocking or permitting activities in real time based on the policy cache 408 and enterprise repository 110.

The SWG 406 monitors and filters web traffic originating from browsers, user apps, or installed applications on the end-user device(s) 104. The secure web gateway 406 performs URL filtering, content inspection, and session validation to detect unauthorized attempts to retrieve GenAI models or related resources. The SWG 406 provides a security layer that ensures traffic complies with enterprise policies before reaching external destinations.

The policy cache 408 is a synchronized local instance of the policy cache 112 inside the mid-link server 400. The policy cache 408 contains rules and enforcement actions defined by the enterprise administrator, such as blocking or permitting GenAI activities. The policy cache 408 allows the mid-link server 400 to apply policies on the end-user device(s) 104 immediately without requiring constant queries to the enterprise server(s) 114, ensuring real-time responsiveness.

The GPU monitor 410 observes GPU usage across end-user device(s) 104. High GPU utilization may indicate GenAI training or GenAI workloads. The GPU monitor 410 compares utilization patterns with pre-defined thresholds of GPU usage and flags abnormal activity for policy enforcement.

The network traffic monitor 412 inspects network flows between the end-user device(s) 104 and external sources. It monitors IP addresses, hostnames, and packet signatures to detect patterns associated with GenAI downloads or executions. The network traffic monitor 412 enables both passive and active scanning of network activity to identify unauthorized GenAI workloads.

The confidence scoring engine 414 analyses downloads, network traffic, GPU usage, and request behavior, to calculate a confidence score. The confidence score represents the likelihood that an end-user device(s) 104 are engaged in unauthorized GenAI activity. Policies are applied to the end-user device(s) 104 based on whether the confidence score exceeds pre-defined thresholds defined by the enterprise administrator.

The application-level requests/response tracker 416 analyzes application-layer traffic such as Hypertext Transfer Protocol (HTTP) and HTTP Secure (HTTPS) requests and responses. The application-level requests/response tracker 416 identifies GenAI model downloads embedded in web traffic and enables policy enforcement. By inspecting application-level interactions, the application-level requests/response tracker 416 ensures visibility into activities that may bypass other GenAI activity monitoring modules.

The identity assignment module 418 assigns unique identifiers to the end-user device(s) 104 that attempt to access or download GenAI models. The identity assignment module 418 associates each identifier with corresponding metadata such as IP addresses, usernames, and accessed URLs. The unique identifiers are stored in the enterprise repository 110, allowing the enterprise administrator to track and block shadow GenAI activity across the enterprise.

The AI detection engine 420 identifies shadow GenAI workloads. The AI detection engine 420 analyzes inputs from the GPU monitor 410, network traffic monitor 412, and application-level requests/response tracker 416 to distinguish between legitimate enterprise workloads and unauthorized GenAI workloads. The AI detection engine 420 enables policy enforcement on the end-user device(s) 104 by identifying shadow GenAI workloads.

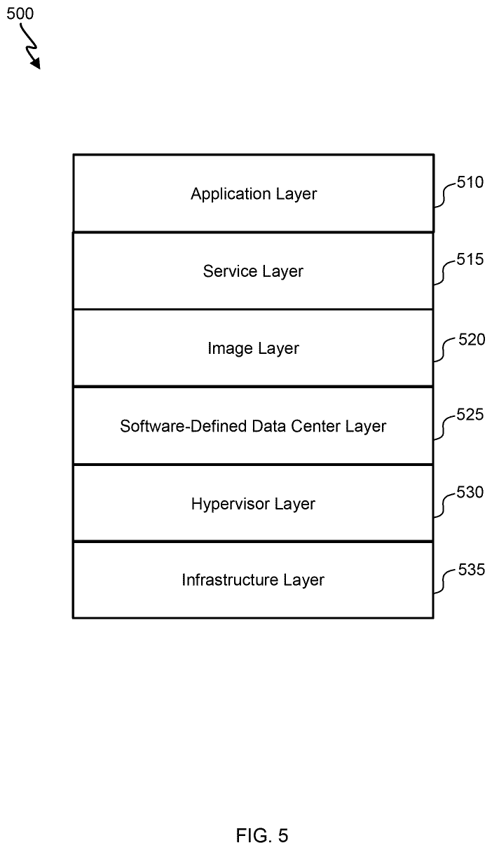

Referring to FIG. 5, a block diagram of an embodiment of a cloud OSI model 500 is shown. The cloud OSI model 500 for cloud computing environments partitions the flow of data in a communication system into six layers of abstraction. The cloud OSI model 500 for cloud computing environments can include, in order, an application layer 510, a service layer 515, an image layer 520, a software-defined data center layer 525, a hypervisor layer 530, and an infrastructure layer 535. The respective layer serves a class of functionality to the layer above it and is served by the layer below it. Classes of functionality can be realized in software by various communication protocols.

The infrastructure layer 535 can include hardware, such as physical devices in a data center, that provides the foundation for the rest of the layers. The infrastructure layer 535 can transmit and receive unstructured raw data between a device and a physical transmission medium. For example, the infrastructure layer 535 can convert the digital bits into electrical, radio, or optical signals.

The hypervisor layer 530 can perform virtualization, which can permit the physical devices to be divided into virtual machines that can be bin packed onto physical machines for greater efficiency. The hypervisor layer 530 can provide virtualized computing, storage, and networking. For example, OpenStack® software that is installed on bare metal servers in a data center can provide virtualization cloud capabilities. The OpenStack® software can provide various infrastructure management capabilities to cloud operators and administrators and can utilize the Infrastructure-as-Code concept for deployment and lifecycle management of a cloud data center. In the Infrastructure-as-Code concept, the infrastructure elements are described in definition files. Changes in the files are reflected in the configuration of data center hosts and cloud services.

The software-defined data center layer 525 can provide resource pooling, usage tracking, and governance on top of the hypervisor layer 530. The software-defined data center layer 525 can enable the creation of virtualization for the Infrastructure-as-Code concept by using representational state transfer (REST) APIs. The management of block storage devices can be virtualized, and end-users can be provided with a self-service API to request and consume those resources, which do not entail any knowledge of where the storage is deployed or on what type of device. Various compute nodes can be balanced for storage.

The image layer 520 can use various operating systems and other pre-installed software components. Patch management can be used to identify, acquire, install, and verify patches for products and systems. Patches can be used to correct security and functionality problems in software. Patches can also be used to add new features to operating systems, including security capabilities. The image layer 520 can focus on the compute in place of storage and networking. The instances within the cloud computing environments can be provided at the image layer 520.

The service layer 515 can provide middleware, such as functional components that applications use in tiers. In some examples, the middleware components can include databases, load balancers, web servers, message queues, email services, or other notification methods. The middleware components can be defined at the service layer 515 on top of particular images from the image layer 520. Different cloud computing environment providers can have different middleware components.

The application layer 510 can interact with software applications that implement a communicating component. The application layer 510 is the layer that is closest to the end-user. Functions of the application layer 510 can include identifying communication partners, determining resource availability, and synchronizing communication. Applications within the application layer 510 can include custom code that makes use of middleware defined in the service layer 515.

Various features discussed above can be performed at a number of layers of the cloud OSI model 500 for cloud computing environments. For example, translating the general policies into specific policies for different cloud computing environments can be performed at the service layer 515 and the software-defined data center layer 525. Various scripts can be updated across the service layer 515, the image layer 520, and the software-defined data center layer 525. Further, APIs and policies can operate at the software-defined data center layer 525 and the hypervisor layer 530.

Respective different cloud computing environments can have different service layers 515, image layer 520, software-defined data center layer 525, hypervisor layer 530, and infrastructure layer 535. Further, respective different cloud computing environments can have an application layer 510 that can make calls to the specific policies in the service layer 515 and the software-defined data center layer 525. The application layer 510 can have noticeably the same format and operation for different cloud computing environments. Accordingly, developers for the application layer 510 do not entail to understand the peculiarities of how respective cloud computing environments operate in the other layers.

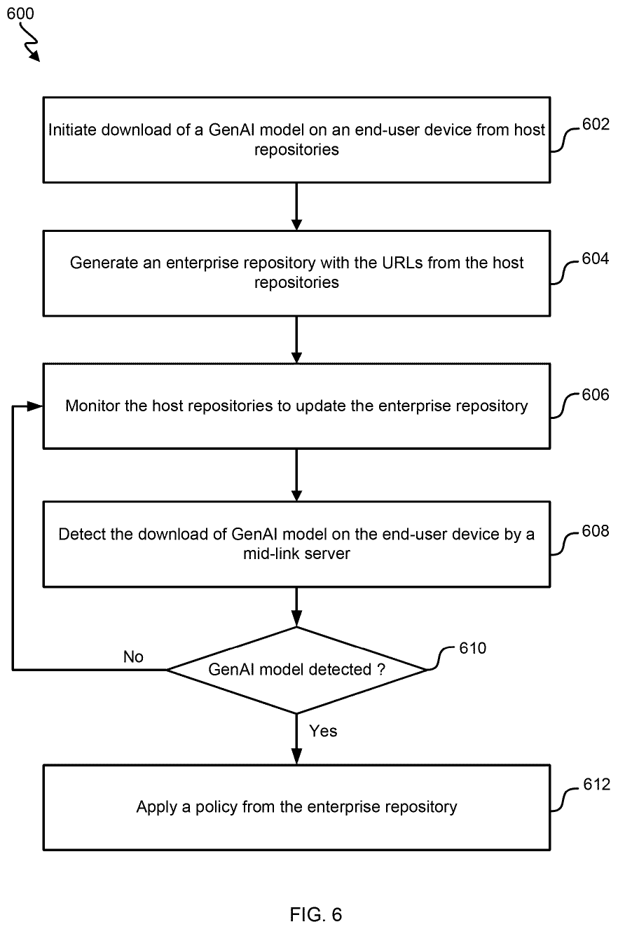

Referring next to FIG. 6, a flowchart of a process 600 for providing continuous visibility of shadow GenAI workloads using a SWG or an inline SWG device is shown. The process 600 begins at block 602, where a user of the end-user device(s) 104 initiates a download of a GenAI model.

At block 602, the download of a GenAI model is initiated from a number of host repositories on an end-user device(s) 104. The request is transmitted through the data communication network(s) 106 and intercepted at the mid-link endpoint 402 of the mid-link server 400. The mid-link endpoint 402 ensures that every download request passes through the mid-link server 400 for inspection and enforcement.

At block 604, an enterprise repository 110 is generated with the URLs obtained from the number of host repositories. The mid-link endpoint 402 communicates with the enterprise repository 110 to record GenAI model URLs, metadata, and associated attributes. The enterprise repository 110 provides a central database of GenAI sources for policy enforcement by the enterprise.

At block 606, the number of host repositories are monitored by the mid-link server 400 to update the enterprise repository 110. The mid-link server 400 retrieves new or modified URLs and synchronizes the URLs with the policy cache 408. The policy cache 408 ensures that updated repository information and corresponding enterprise policies are locally available for enforcement by the mid-link server 400.

At block 608, the mid-link server 400 detects the downloading of a GenAI model on the end-user device(s) 104. The secure web gateway 406 and the cloud access security broker 404 of the mid-link server 400 performs inspection of the traffic between the end-user device(s) 104 and the number of host repositories. The secure web gateway 406 and the cloud access security broker 404 analyzes URL requests, workloads, and traffic to identify downloads associated with GenAI models.

At block 610, the mid-link server 400 determines whether a GenAI model has been detected on the end-user device(s) 104. If no GenAI model is detected, the mid-link server 400 returns to block 606 to continue monitoring the number of host repositories. If a GenAI model is detected, the mid-link server 400 proceeds to block 612. The determination at block 610 relies on the secure web gateway 406, and the cloud access security broker 404, of the mid-link server 400.

At block 612, a policy from a number of policies stored in the enterprise repository 110 and synchronized with the policy cache 408 is applied to the end-user device(s) 104 by the mid-link server 400. The mid-link server 400 ensures that the policy enforcement action corresponds with the number of policies of the enterprise, such as blocking, permitting, or logging the detected GenAI model download activity.

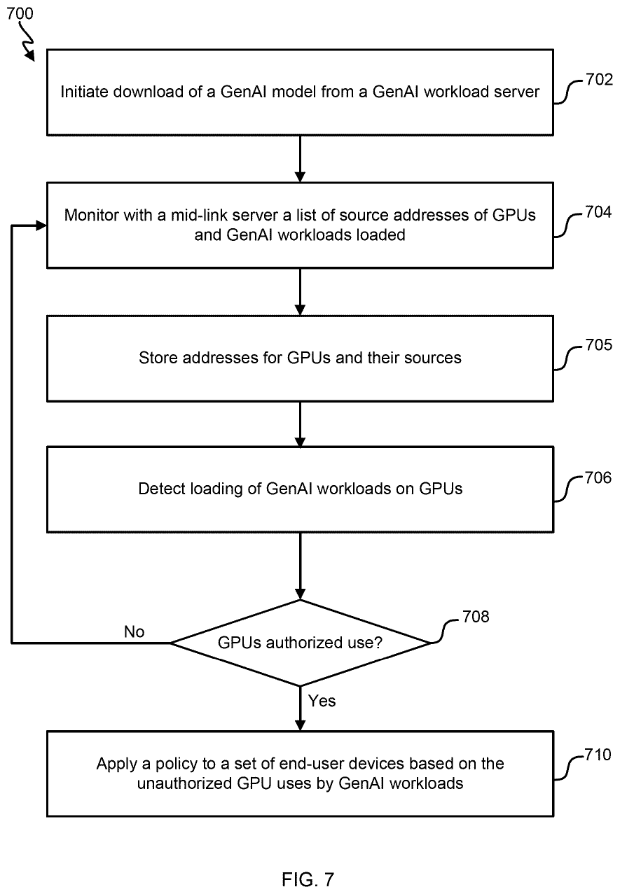

Referring to FIG. 7, a flowchart of a process 700 for providing continuous visibility of shadow GenAI workloads using a list of GPUs.

At block 702, a download of a GenAI model is initiated from a GenAI workload server on an end-user device(s) 104. The request from the end-user device(s) 104 is transmitted through the data communication network(s) 106 and the request is intercepted by the mid-link endpoint 402 of the mid-link server 400 for further monitoring.

At block 704, the GPU monitor 410 of the mid-link server 400 monitors a list of GPUs by their IP addresses and hostnames for a number of end-user device(s) 104. The GPU monitor 410 retrieves GPU utilization data using information stored in the enterprise repository 110 of the enterprise server(s) 114 and correlates the data with the policy cache 408 for enforcement of the number of policies of the enterprise.

In block 705, the location of the GPUs by IP address and hostname are stored. Future use of these addresses is likely to indicate GenAI workloads. Future use of those addresses is presumed to be GenAI workloads.

At block 706, the GPU monitor 410 of the mid-link server 400 determines the list of GPUs of the number of end-user device(s) 104 interacting with the GPUs. The GPU monitor 410 evaluates the workloads of the GPUs and identifies abnormal activity consistent with downloading or execution of GenAI models.

At block 708, the mid-link server 400 evaluates whether the GPUs monitored by the GPU monitor 410 have been loaded with GenAI workloads, the GPU monitor 410 continues monitoring at block 704. If GenAI workloads are detected, the mid-link server 400 proceeds to block 710 or otherwise limit use of the GPUs.

At block 710, a policy from the number of policies stored in the enterprise repository 110 and synchronized with the policy cache 408 is applied by the mid-link server 400 to the set of end-user device(s) 104. The set of end-user device(s) 104 have GPUs that are unauthorized for use. The mid-link server 400 enforces the policy by restricting, permitting, or logging the GenAI workload execution in accordance with the number of policies of the enterprise.

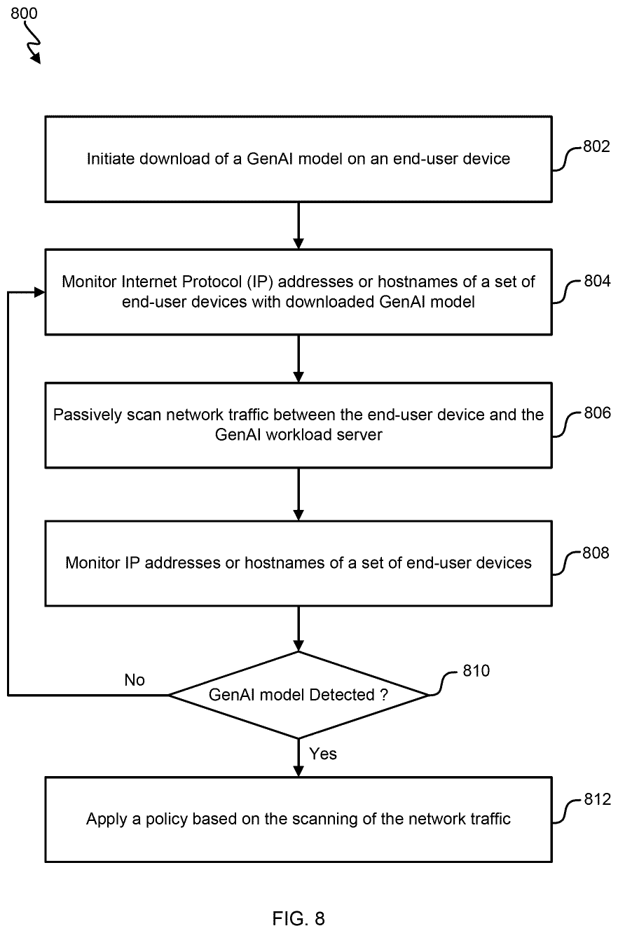

Referring to FIG. 8, a flowchart of a process 800 for providing continuous visibility of shadow GenAI workloads by scanning network traffic between an end-user device(s) 104 and a GenAI workload server is shown.

At block 802, a download of a GenAI model is initiated on an end-user device(s) 104 by a user of a number of users of an enterprise from a GenAI workload server. The request from the end-user device(s) 104 is transmitted through the data communication network(s) 106 and is intercepted by the mid-link endpoint 402 of the mid-link server 400 for monitoring.

At block 804, the network traffic monitor 412 of the mid-link server 400 monitors Internet Protocol (IP) addresses or hostnames of a set of end-user device(s) 104 that have previously downloaded GenAI models. The network traffic monitor 412 retrieves relevant device and network information from the enterprise repository 110 of the enterprise server(s) 114 and correlates the data with the policy cache 408 for policy enforcement.

At block 806, the network traffic monitor 412 of the mid-link server 400 passively scans network traffic between the end-user device(s) 104 and the GenAI workload server. The network traffic monitor 412 inspects packets and session metadata to detect indications of GenAI model downloads or executions while ensuring compliance with the enterprise policies stored in the policy cache 408.

At block 808, the network traffic monitor 412 of the mid-link server 400 continues to monitor IP addresses or hostnames of the set of end-user device(s) 104 that have initiated or completed GenAI model downloads.

At block 810, the mid-link server 400 determines whether a GenAI model has been detected on the monitored end-user device(s) 104. If no GenAI model is detected, the network traffic monitor 412 continues monitoring at block 804. If a GenAI model is detected, the mid-link server 400 proceeds to block 812.

At block 812, a policy from the number of policies stored in the enterprise repository 110 and synchronized with the policy cache 408 is applied by the mid-link server 400 based on the scanning performed by the network traffic monitor 412. The mid-link server 400 enforces the policy by restricting, permitting, or logging GenAI model download activities in accordance with the number of policies defined by the enterprise. The policies are updated based on a change in the suspicious activity identified on the end-user device(s) 104. For example, if the suspicious activity identified on the end-user device(s) 104 continues, the policy of partially blocking access is changed to blocked.

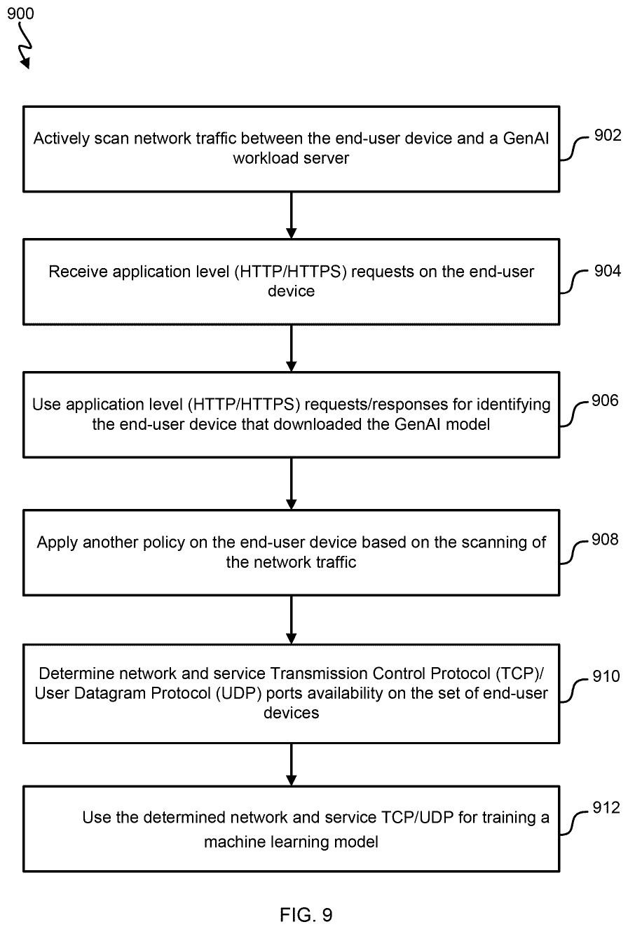

Referring to FIG. 9, a flowchart of a process 900 for providing continuous visibility of shadow GenAI workloads using HTTP/HTTPS requests/responses is shown.

[At block 902, the mid-link server 400 actively scans network traffic between the end-user device(s) 104 and a GenAI workload server. The scanning is performed by the application-level requests/response tracker 416 of the mid-link server 400, which monitors application-level interactions to detect unauthorized GenAI model downloads or executions.

At block 904, the application-level requests/response tracker 416 of the mid-link server 400 receives application-level (HTTP/HTTPS) requests from the end-user device(s) 104 and the corresponding application responses from the GenAI workload server. The application-level requests/response tracker 416 inspects the requests and responses to identify access patterns and data exchanges related to GenAI models.

At block 906, the application-level requests/response tracker 416 of the mid-link server 400 uses the received HTTP/HTTPS requests and responses to identify the end-user device(s) 104 that has downloaded or is downloading a GenAI model. The application-level requests/response tracker 416 correlates the information with IP addresses, hostnames, and session data stored in the enterprise repository 110 and synchronized with the policy cache 408.

At block 908, the mid-link server 400 applies a policy from the number of policies stored in the enterprise repository 110 and synchronized with the policy cache 408 on the identified end-user device(s) 104. The mid-link server 400 enforces the policy by restricting, permitting, or logging GenAI model downloads in accordance with the number of policies of the enterprise.

At block 910, the application-level requests/response tracker 416 of the mid-link server 400 determines network and service Transmission Control Protocol (TCP) and User Datagram Protocol (UDP) port availability on the set of end-user device(s) 104 based on active scanning of the network traffic. The port data is correlated with the number of policies of the enterprise stored in the policy cache 408 to support workload monitoring and control on the end-user device(s) 104.

At block 912, the mid-link server 400 uses the determined TCP/UDP network and service port data from the application-level requests/response tracker 416 for training a machine learning model. The trained machine learning model improves the ability of the mid-link server 400 to identify unauthorized GenAI workload activity and enforce appropriate enterprise policies on end-user device(s) 104.

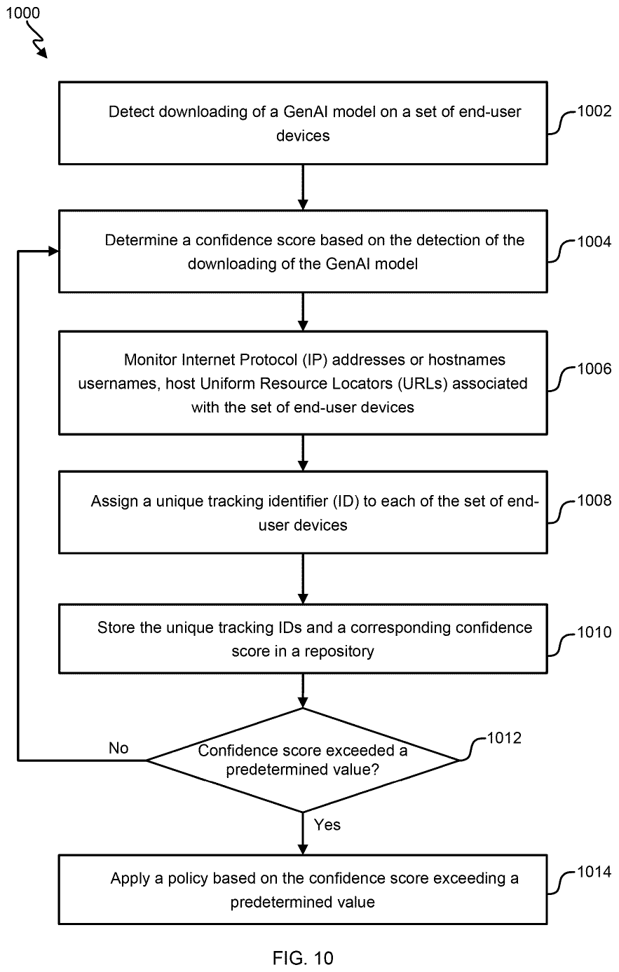

Referring to FIG. 10, a flowchart of a process 1000 for providing continuous visibility of shadow GenAI workloads using a confidence score based on the detection of the downloading of the GenAI model is shown.

At block 1002, the AI detection engine 420 of the mid-link server 400 detects downloading of a GenAI model on a set of end-user device(s) 104. The AI detection engine 420 analyzes inputs from the network traffic monitor 412, the application-level requests/response tracker 416, and the GPU monitor 410 to identify activities that indicate GenAI model download or execution.

At block 1004, the confidence scoring engine 414 of the mid-link server 400 determines a confidence score based on the detection of the downloading of the GenAI model. The confidence scoring engine 414 correlates the AI detection results, GPU usage patterns, and network traffic signatures to compute a score representing the likelihood that an end-user device(s) 104 is engaged in an unauthorized GenAI activity.

At block 1006, the network traffic monitor 412 and the application-level requests/response tracker 416 monitors IP addresses, hostnames, usernames, and URLs associated with the set of end-user device(s) 104 that have downloaded GenAI models. This monitoring provides ongoing visibility into communications related to the detected GenAI workload.

At block 1008, the ID assignment module 418 of the mid-link server 400 assigns a unique tracking identifier (ID) to each of the set of end-user device(s) 104. Each identifier is linked with device metadata such as IP address, username, and download history, enabling consistent tracking across the enterprise.

At block 1010, the database 422 of the mid-link server 400 stores the unique tracking identifiers and the corresponding confidence scores. The enterprise repository 110 is updated with the unique tracking identifiers and the corresponding confidence scores.

At block 1012, the confidence scoring engine 414 evaluates whether the confidence score exceeds a pre-defined threshold value. If the confidence score does not exceed the pre-defined threshold value, the process returns to block 1004 for continued monitoring and recalculation based on subsequent activity. If the confidence score exceeds the pre-defined threshold value, the process advances to block 1014.

At block 1014, a policy from the number of policies stored in the enterprise repository 110 and synchronized with the policy cache 408 is applied by the mid-link server 400. The confidence score is updated in the enterprise repository 110 for analysis when the confidence score is below the predetermined value and correlate the confidence score at each detection for updating the confidence score in the enterprise repository 110. The mid-link server 400 enforces the selected policy by restricting, permitting, or logging GenAI-related activity in real time. This ensures that shadow GenAI workloads are managed in accordance with the number of policies of the enterprise while maintaining continuous visibility of GenAI usage.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, non-volatile, or other storage medium and is not to be limited to any particular type of memory or number of memories, or type of media upon which memory is stored.

In the embodiments described above, for the purposes of illustration, processes may have been described in a particular order. It should be appreciated that in alternate embodiments, the methods may be performed in a different order than that described. It should also be appreciated that the methods and/or system components described above may be performed by hardware and/or software components (including integrated circuits, processing units, and the like), or may be embodied in sequences of machine-readable, or computer-readable, instructions, which may be used to cause a machine, such as a general-purpose or special-purpose processor or logic circuits programmed with the instructions to perform the methods. Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data. These machine-readable instructions may be stored on one or more machine-readable mediums, such as CD-ROMs or other type of optical disks, solid-state drives, tape cartridges, ROMs, RAMs, EPROMS, EEPROMs, magnetic or optical cards, flash memory, or other types of machine-readable mediums suitable for storing electronic instructions. Alternatively, the methods may be performed by a combination of hardware and software.

Implementation of the techniques, blocks, steps, and means described above may be done in various ways. For example, these techniques, blocks, steps, and means may be implemented in hardware, software, or a combination thereof. For a digital hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof. For analog circuits, they can be implemented with discreet components or using monolithic microwave integrated circuit (MMIC), radio frequency integrated circuit (RFIC), and/or micro electro-mechanical systems (MEMS) technologies.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine-readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

The methods, systems, devices, graphs, and tables discussed herein are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims. Additionally, the techniques discussed herein may provide differing results with different types of context awareness classifiers.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art.

While the principles of the disclosure have been described above in connection with specific apparatuses and methods, it is to be clearly understood that this description is made only by way of example and not as limitation on the scope of the disclosure.

1. A method for providing continuous visibility of shadow generative artificial intelligence (GenAI) workloads, the method comprising:
receiving initiation of a download of a GenAI model from one or more host repositories of a hosting site, wherein the one or more host repositories comprise uniform resource locators (URLs) of the GenAI model, and data associated with model owner, model source repositories, model partner, open-source models, and model containers;
generating an enterprise repository with the URLs of the GenAI model by retrieving the URLs from the one or more host repositories;
monitoring the one or more host repositories for updating the enterprise repository, wherein the enterprise repository has a plurality of policies associated with a corresponding GenAI model;
detecting, by a mid-link server, the downloading of the GenAI model, wherein the mid-link server is between a plurality of end-user devices of a plurality of users and an enterprise server, the mid-link server deploys a Secure Web Gateway (SWG) or an inline Cloud Access Security Broker (CASB) device for detecting the downloading of the GenAI model, wherein the SWG and the inline CASB device are deployed at the enterprise server to intercept encrypted network traffic from the plurality of end-user devices to the hosting site, wherein the mid-link server further detects downloading of GenAI related machine learning operation (MLOps) tools and frameworks on an end-user device, the downloading including fine-tuning tools, quantization tools, and integration tools of the GenAI model with other production components; and
applying a policy from the plurality of policies from the enterprise repository based on the detection of the downloading of the GenAI model and the GenAI related MLOps tools and the frameworks, wherein the policy from the plurality of policies is determined based on aggregated risk assessments associated with the plurality of users for downloading the GenAI model and the GenAI related MLOps tools and the frameworks, and wherein the policy determine whether the GenAI model or the GenAI related MLOps tools and the frameworks download or usage is permitted, blocked, or flagged.

2. The method for providing continuous visibility of shadow generative artificial intelligence (GenAI) workloads of claim 1, wherein
the MLOps tools and the frameworks added to a monitoring list in the enterprise repository comprise one or more of:
Weights and Biases, LangChain, LlamaIndex, SpinQuant, PyTorch, TensorFlow, Qdrant, MLFlow, Metaflow, and Ollama.

3. The method for providing continuous visibility of shadow generative artificial intelligence (GenAI) workloads of claim 1, further comprising:
detecting, by the mid-link server, downloading of the GenAI model on the end-user device and downloading of GenAI-related workload components, wherein the GenAI-related workload components comprise a proxy server, a Software Development Kit (SDK), and GenAI guardrails;
applying a first policy from the plurality of policies based on the detection of the GenAI-related workload components on the end-user device; and
updating the plurality of policies based on an updated enterprise repository, wherein the plurality of policies includes sending alerts to an enterprise administrator, and blocking or permitting an installation of the GenAI model.

4. The method for providing continuous visibility of shadow generative artificial intelligence (GenAI) workloads of claim 1, further comprising:
monitoring Internet Protocol (IP) addresses or hostnames of a set of end-user devices that has the GenAI model, the MLOps tools, frameworks, or GenAI related workload components downloaded by a set of end-users; and
applying a second policy from the plurality of policies based on the monitoring of the IP addresses or the hostnames.

5. The method for providing continuous visibility of shadow generative artificial intelligence (GenAI) workloads of claim 1, further comprising:
monitoring, by the mid-link server, IP addresses and hostnames of Graphical Processing Units (GPUs) of the plurality of end-user devices from the enterprise repository of the enterprise server, wherein the GenAI model is downloaded by a user of the plurality of users from a GenAI workload server;
detecting of GenAI models, the MLOps tools and other AI software being loaded on the GPUs; and
applying a first policy from the plurality of policies to a set of end-user devices based on the detecting GenAI models, the tools and other AI software.

6. The method for providing continuous visibility of shadow generative artificial intelligence (GenAI) workloads of claim 1, further comprising:
monitoring Internet Protocol (IP) addresses or hostnames of a set of end-user devices that has the GenAI model downloaded by a set of end-users;
passively scanning, by the mid-link server, network traffic between the end-user device and a GenAI workload server, wherein the network traffic includes GenAI request/response, and the scanning is performed using a machine learning model to detect the GenAI request/response; and
applying a first policy from the plurality of policies based on the scanning of the network traffic and the monitoring of the IP addresses or the hostnames of the set of end-user devices that has the GenAI model initiated or downloaded.

7. The method for providing continuous visibility of shadow generative artificial intelligence (GenAI) workloads of claim 6, further comprising:
actively scanning, by the mid-link server, the network traffic between the end-user device and the GenAI workload server;
receiving application-level hypertext transfer protocol/hypertext transfer protocol secure (HTTP/HTTPS) requests on the plurality of end-user devices for getting application responses;
using application-level (HTTP/HTTPS) requests/responses for identifying the end-user device that downloaded the GenAI model;
applying a second policy from the plurality of policies on the end-user device based on the scanning of the network traffic and the monitoring of the GenAI request/response;
determining network and service Transmission Control Protocol (TCP)/User Datagram Protocol (UDP) ports availability on the set of end-user devices based on the active scanning of the network traffic by the mid-link server; and
using the determined network and service TCP/UDP for training the machine learning model, wherein the passively scanning and the actively scanning of the network traffic comprise identifying TCP/UDP port information, which is used for determining application services that are available on the set of end-user devices.

8. The method for providing continuous visibility of shadow generative artificial intelligence (GenAI) workloads of claim 7, further comprising:
applying, by the mid-link server, artificial intelligence (AI) red teaming tool for validating the end-user device;
identifying vulnerabilities on the end-user device based on the validation; and
applying a third policy from the plurality of policies on the end-user device based on the validation.

9. The method for providing continuous visibility of shadow generative artificial intelligence (GenAI) workloads of claim 1, further comprising:
detecting downloading of the GenAI model on a set of end-user devices;
determining a confidence score based on the detection of the downloading of the GenAI model;
monitoring Internet Protocol (IP) addresses or hostnames usernames, host Uniform Resource Locators (URLs) associated with the set of end-user devices that has the GenAI model downloaded by a set of end-users;
assigning a unique tracking identifier (ID) to each of the set of end-user devices of the set of end-users;
storing the unique tracking ID and a corresponding confidence score in a repository; and
applying a policy from the plurality of policies based on the confidence score exceeding a predetermined value, wherein the policy includes blocking the end-user device that has the confidence score exceeding the predetermined value, or updating the confidence score in the repository for analysis when the confidence score is below the predetermined value, and correlating the confidence score at each detection for updating the confidence score in the repository.

10. A shadow generative artificial intelligence (GenAI) detection system for providing continuous visibility of shadow generative artificial intelligence (GenAI) workloads, the shadow generative artificial intelligence (GenAI) detection system comprising:
one or more processors, and
memory couples with the one or more processors, the memory configured to store instructions that when executed by the one or more processors cause the one or more processors to:
receive initiation of a download of a GenAI model from one or more host repositories of a hosting site, wherein the one or more host repositories comprise uniform resource locators (URLs) of the GenAI model, and data associated with model owner, model source repositories, model partner, open-source models, and model containers;
generate an enterprise repository with the URLs of the GenAI model by retrieving the URLs from the one or more host repositories;
monitor the one or more host repositories for updating the enterprise repository, wherein the enterprise repository has a plurality of policies associated with a corresponding GenAI model;
detect, by a mid-link server, the downloading of the GenAI model, wherein the mid-link server is between a plurality of end-user devices of a plurality of users and an enterprise server, and the mid-link server deploys a Secure Web Gateway (SWG) or an inline Cloud Access Security Broker (CASB) device for detecting the downloading of the GenAI model, wherein the SWG and the inline CASB device are deployed at the enterprise server to intercept encrypted network traffic from the plurality of end-user devices to the hosting site, wherein the mid-link server further detects downloading of GenAI related machine learning operation (MLOps) tools and frameworks on an end-user device, the downloading including fine-tuning tools, quantization tools, and integration tools of the GenAI model with other production components; and
apply a policy from the plurality of policies from the enterprise repository based on the detection of the downloading of the GenAI model and the GenAI related MLOps tools and the frameworks, wherein the policy from the plurality of policies is determined based on aggregated risk assessments associated with the plurality of users for downloading the GenAI model and the GenAI related MLOps tools and the frameworks, and wherein the policy determine whether the GenAI model or the GenAI related MLOps tools and the frameworks download or usage is permitted, blocked, or flagged.

11. The shadow generative artificial intelligence (GenAI) detection system for providing continuous visibility of shadow generative artificial intelligence (GenAI) workloads of claim 10, wherein
the MLOps tools and frameworks added to a monitoring list in the enterprise repository comprise two or more items from: Weights and Biases, LangChain, LlamaIndex, SpinQuant, PyTorch, TensorFlow, Qdrant, MLFlow, Metaflow, and Ollama.

12. The shadow generative artificial intelligence (GenAI) detection system for providing continuous visibility of shadow generative artificial intelligence (GenAI) workloads of claim 10, wherein the instructions that when executed by the one or more processors further cause the one or more processors to:
detect, by the mid-link server, downloading of the GenAI model on the end-user device and downloading of GenAI-related workload components, wherein the GenAI-related workload components include a proxy server, a Software Development Kit (SDK), and GenAI guardrails;
apply a first policy from the plurality of policies based on the detection of the GenAI-related workload components on the end-user device; and
update the plurality of policies based on an updated enterprise repository, wherein the plurality of policies includes sending alerts to an enterprise administrator, and blocking or permitting an installation of the GenAI model.

13. The shadow generative artificial intelligence (GenAI) detection system for providing continuous visibility of shadow generative artificial intelligence (GenAI) workloads of claim 10, wherein the instructions that when executed by the one or more processors further cause one or more processors to:
monitor Internet Protocol (IP) addresses or hostnames of a set of end-user devices that has the GenAI model downloaded by the set of end-users; and
apply a second policy from the plurality of policies based on the monitoring of the IP addresses or the hostnames.

14. The shadow generative artificial intelligence (GenAI) detection system for providing continuous visibility of shadow generative artificial intelligence (GenAI) workloads of claim 10, wherein the instructions that when executed by the one or more processors further cause one or more processors to:
monitor, by the mid-link server, IP addresses and hostnames for a list of Graphical Processing Units (GPUs) of the plurality of end-user devices from the enterprise repository of the enterprise server, wherein the GenAI model is downloaded by a user of the plurality of users from a GenAI workload server;
detect of GenAI models, the MLOps tools and other AI software being loaded on the GPUs; and
apply a first policy from the plurality of policies to a set of end-user device(s) based on the detect of GenAI models, the tools and other AI software.

15. The shadow generative artificial intelligence (GenAI) detection system for providing continuous visibility of shadow generative artificial intelligence (GenAI) workloads of claim 10, wherein the instructions that when executed by the one or more processors further cause the one or more processors to:
monitor Internet Protocol (IP) addresses or hostnames of a set of end-user devices that has the GenAI model downloaded by a set of end-users;
passively scan, by the mid-link server, network traffic between the end-user device and a GenAI workload server, wherein the network traffic includes GenAI request/response, and the scanning is performed using a machine learning model to detect the GenAI request/response; and
apply a first policy from the plurality of policies based on the scanning of the network traffic and the monitoring of the IP addresses or the hostnames of the set of end-user device(s) that has the GenAI model initiated or downloaded.

16. The shadow generative artificial intelligence (GenAI) detection system for providing continuous visibility of shadow generative artificial intelligence (GenAI) workloads of claim 15, wherein the instructions that when executed by the one or more processors further cause the one or more processors to:
actively scan, by the mid-link server, the network traffic between the end-user device and the GenAI workload server;
receive application-level hypertext transfer protocol/hypertext transfer protocol secure (HTTP/HTTPS) requests on the plurality of end-user devices for getting application responses;
use application-level (HTTP/HTTPS) requests/responses for identifying the end-user device that downloaded the GenAI model;
apply a second policy from the plurality of policies on the end-user device based on the scanning of the network traffic and the monitoring of the GenAI request/response;
determine network and service Transmission Control Protocol (TCP)/User Datagram Protocol (UDP) ports availability on the set of end-user devices based on the active scanning of the network traffic by the mid-link server; and
use the determined network and service TCP/UDP for training the machine learning model, wherein the passively scanning and the actively scanning of the network traffic comprise identifying TCP/UDP port information, which is used for determining application services that are available on the set of end-user devices.

17. The shadow generative artificial intelligence (GenAI) detection system for providing continuous visibility of shadow generative artificial intelligence (GenAI) workloads of claim 16, wherein the instructions that when executed by the one or more processors further cause the one or more processors to:
apply, by the mid-link server, artificial intelligence (AI) red teaming tool for validating the end-user device;
identify vulnerabilities on the end-user device based on the validation; and
apply a third policy from the plurality of policies on the end-user device based on the validation.

18. The shadow generative artificial intelligence (GenAI) detection system for providing continuous visibility of shadow generative artificial intelligence (GenAI) workloads of claim 10, wherein the instructions that when executed by the one or more processors further cause the one or more processors to:
detect downloading of the GenAI model on a set of end-user devices;
determine a confidence score based on the detection of the downloading of the GenAI model;
monitor Internet Protocol (IP) addresses or hostnames usernames, host Uniform Resource Locators (URLs) associated with the set of end-user devices that has the GenAI model downloaded by a set of end-users;
assign a unique tracking identifier (ID) to each of the set of end-user devices of the set of end-users;
store the unique tracking ID and a corresponding confidence score in a repository; and
apply a policy from the plurality of policies based on the confidence score exceeding a predetermined value, wherein the policy includes blocking the end-user device that has the confidence score exceeding the predetermined value, or updating the confidence score in the repository for analysis when the confidence score is below the predetermined value, and correlating the confidence score at each detection for updating the confidence score in the repository.

19. A non-transitory computer-readable storage medium having stored thereon instructions for causing at least one computer to execute a method for providing continuous visibility of shadow generative artificial intelligence (GenAI) workloads, wherein the method comprising:
receiving initiation of a download of a GenAI model from one or more host repositories of a hosting site, wherein the one or more host repositories comprise uniform resource locators (URLs) of the GenAI model, and data associated with model owner, model source repositories, model partner, open-source models, and model containers;
generating an enterprise repository with the URLs of the GenAI model by retrieving the URLs from the one or more host repositories;
monitoring the one or more host repositories for updating the enterprise repository, wherein the enterprise repository has a plurality of policies associated with a corresponding GenAI model;
detecting by a mid-link server, the downloading of the GenAI model, wherein the mid-link server is between a plurality of end-user device(s) of a plurality of users and an enterprise server, and the mid-link server deploys a Secure Web Gateway (SWG) or an inline Cloud Access Security Broker (CASB) device for detecting the downloading of the GenAI model, wherein the SWG and the inline CASB device are deployed at the enterprise server to intercept encrypted network traffic from the plurality of end-user device(s) to the hosting site, wherein the mid-link server further detects downloading of GenAI related machine learning operation (MLOps) tools and frameworks on an end-user device, the downloading including fine-tuning tools, quantization tools, and integration tools of the GenAI model with other production components; and
applying a policy from the plurality of policies from the enterprise repository based on the detection of the downloading of the GenAI model and the GenAI related MLOps tools and the frameworks, wherein the policy from the plurality of policies is determined based on aggregated risk assessments associated with the plurality of users for downloading the GenAI model and the GenAI related MLOps tools and the frameworks, and wherein the policy determine whether the GenAI model or the GenAI related MLOps tools and the frameworks download or usage is permitted, blocked, or flagged.

20. The non-transitory computer-readable storage medium of claim 19, wherein
the MLOps tools and the frameworks added to a monitoring list in the enterprise repository comprise two or more from:
Weights and Biases, LangChain, LlamaIndex, SpinQuant, PyTorch, TensorFlow, Qdrant, MLFlow, Metaflow, and Ollama.
